(19) United States
(12) Patent Application Publication
(10) Pub. No.: US 2021/0110602 A1
(43) Pub. Date: Apr. 15, 2021

(54) THREE-DIMENSIONAL REGISTRATION PROCEDURES

(71) Applicant: Hewlett-Packard Development Company, L.P., Spring, TX (US)

(72) Inventors: Faisal Azhar, Bristol (GB); Stephen Bernard Pollard, Bristol (GB)

(73) Assignee: Hewlett-Packard Development Company, L.P., Spring, TX (US)

(21) Appl. No.: 17/043,838

(22) PCT Filed: Jun. 25, 2018
(86) PCT No.: PCT/US2018/039370

§ 371 Date: Sep. 30, 2020

(51) Int. Cl. G06T 17/20; G06T 7/73; G06T 7/32; G06K 9/62

(52) U.S. Cl. CPC G06T 17/20; G06T 7/75; G06T 2210/56; G06K 9/6211; G06T 7/32

(57) ABSTRACT

Examples of the present disclosure relate to a method of performing a three-dimensional registration procedure to align two or more three-dimensional surfaces.

### BACKGROUND

Three-dimensional (3D) registration may be used to align two or more 3D surfaces with one another. Digital representations of full or partial 3D surfaces may be obtained from a variety of sources such as 3D scans of real-world objects, 3D imaging of real-world objects, or computer-aided design models of objects etc.

### BRIEF DESCRIPTION OF THE DRAWINGS

Various features of the present disclosure will be apparent from the detailed description which follows, taken in conjunction with the accompanying drawings, which together illustrate, features of certain examples, and wherein:

FIG. 1a is a schematic representation of an example of a point cloud of a 3D surface;

FIG. 1b is a schematic representation of an example of a surface duplet sampled from a 3D surface;

FIG. 2 is an example flowchart of a procedure for matching duplet pairs;

FIG. 3a is a schematic representation of an example of a 3D surface with a Gaussian curvature of zero;

FIG. 3b is a schematic representation of an example of a 3D surface with a positive Gaussian curvature;

FIG. 3c is a schematic representation of an example of a 3D surface with a negative Gaussian curvature;

FIG. 4a is an example of a 3D schematic representation of discrete triangularization of a 3D surface;

FIG. 4b is an example of a 2D schematic representation of discrete triangularization of a 3D surface;

FIG. 5 is a block diagram of an example of a method for performing a 3D registration procedure;

FIG. 6 is an example flowchart of a procedure for performing 3D registration;

FIG. 7a is an example comparison of 3D registration results of 3D registration procedures;

FIG. 7b is an example comparison of 3D registration results of 3D registration procedures; and

FIG. 8 is an example of a schematic diagram of a processor and machine-readable storage medium for performing a 3D registration procedure.

FIG. 9 is an example of a schematic diagram of a computer system for performing a 3D registration procedure.

### DETAILED DESCRIPTION

Certain examples described herein allow a 3D registration procedure to be performed to align a first 3D surface with a second 3D surface. In particular, certain examples make use of an intrinsic surface property of the 3D surfaces, that can enable a more robust and accurate alignment of the first 3D surface with the second 3D surface.

In certain examples, the intrinsic surface property of the 3D surfaces may be a Gaussian curvature. This may provide a more robust alignment of the 3D surfaces by filtering surface duplet pairs that are used to compute a pose estimate. As a result, the surface duplet pairs that have similar Gaussian curvatures are used to compute the pose estimate, thus improving the accuracy of the initial alignment.

In certain examples, the Gaussian curvature of a 3D surface may be pre-computed to decrease the computational resources needed to perform the 3D registration procedure. For example, the Gaussian curvature of the first and/or second 3D surface may be pre-computed. In certain examples, a 3D surface may be discretely triangularized in order to increase the efficiency of computing the Gaussian surface.

Performing a robust 3D registration procedure, whereby two 3D surfaces may be accurately aligned, may involve computing a pose estimate for aligning a 3D surface relative to another 3D surface.

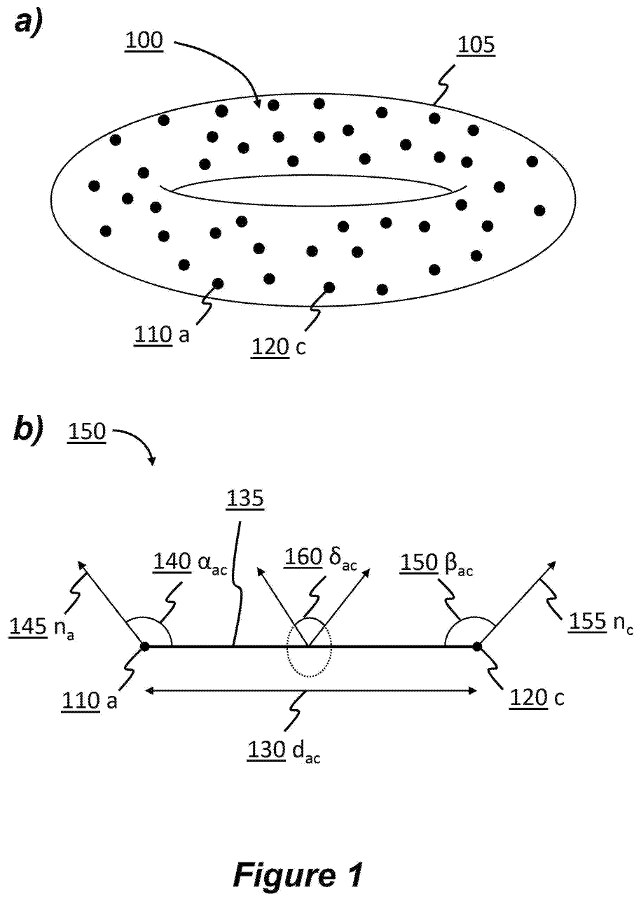

FIG. 1a is a schematic representation of an example of a point cloud 100 of a 3D surface. A point cloud 100 is a set of data points 110, 120 in space, in which each point 110, 120 has defined position in space which may be represented by an x, y and z geometric co-ordinate. Point clouds are used to represent 3D surfaces. FIG. 1a shows a simple 3D surface of a torus, illustrated by the lines 105, and the corresponding point cloud 100. The point cloud comprises many multiple points, such as point a 110 and point c 120.

Point clouds can be produced by a 3D scanner to digitally represent the shape and appearance of a real-world object. Furthermore, point clouds may be used to create 3D computer-aided design (CAD) models of said objects. A point cloud may comprise a set of orientated points. An orientated point may comprise the location or position of a point in three dimensions and a corresponding surface normal of the point. Herewith, an orientated point will be referred to as a point.

3D point cloud registration or point set registration is a process whereby two or more, complete or partial, point clouds are accurately aligned. For example, a partial point cloud produced by a 3D scanner may be aligned with a complete CAD model. A 3D registration procedure aligns point clouds, or 3D surfaces, by calculating a transformation between them i.e. a transformation that when applied to one point cloud will align it with another point cloud. The transformation to align the 3D surfaces may be referred to as a pose estimate. In many cases, alignment will not be a perfect alignment of surfaces but rather a best effort alignment between the 3D surfaces, since similar 3D surfaces will rarely align perfectly.

A 3D registration procedure may involve aligning a first 3D surface with a second 3D surface by sampling a first pair of points from the first 3D surface and sampling a second pair of points from the second 3D surface. The first pair of points may be referred to as a first surface duplet. Similarly, the second pair of points may be referred to as a second surface duplet.

FIG. 1b is a schematic representation of an example of a surface duplet 150 sampled from a 3D surface. For example, the 3D surface may be the point cloud 100 of FIG. 1a. The surface duplet 150 may, for example, comprise the points a 110 and c 120 from FIG. 1a. The line connecting points a 110 and c 120 is shown in FIG. 1b as line 135. The surface duplet may be characterized by one or more geometric features from a set of possible geometric features 130, 140, 145, 150, 155, 160. One geometric feature may be, for example, the Euclidean distance d_{ac} 130 along the line 135 between the point a 110 and the point c 120 of the surface duplet. The surface normal associated with point a 110 is shown by arrow nₐ 145, and the surface normal associated with point c 120 is shown by arrow n_{c} 155.

Further geometric features of the surface duplet 150 may include:

1) the angle α_{ac} 140 between the normal nₐ 145 and the line 135 connecting point a 110 and point c 120;

2) the angle β_{ac} 150 between the normal n_{c} 155 and the line 135 connecting point a 110 and point c 120; and

3) the angle δ_{ac} 160 between the normal nₐ and the normal n_{c} around the line 135 connecting point a 110 and point c 120.

The geometric features of a first surface duplet from a first 3D surface, such as those described above, may be compared with the geometric features of a second surface duplet from a second 3D surface to establish a correspondence or match. Surface duplets with matching geometric features may be used to generate a pose estimate for 3D registration.

In some examples, the surface duplet may be characterized by one or more non-geometric features from a possible set of non-geometric features such as the 2D texture or the color of the surface. Surface duplets may be characterized by a combination of both geometric and non-geometric features.

A pose estimate T may be a homogeneous 4×4 transformation matrix that aligns a first 3D surface with a second 3D surface. The pose estimate or transformation matrix may translate and/or rotate a first 3D surface to align the first 3D surface with the second 3D surface. A robust pose estimate may consistently and accurately align a first 3D surface with a second 3D surface, effectively overlapping or superimposing the two 3D surfaces.

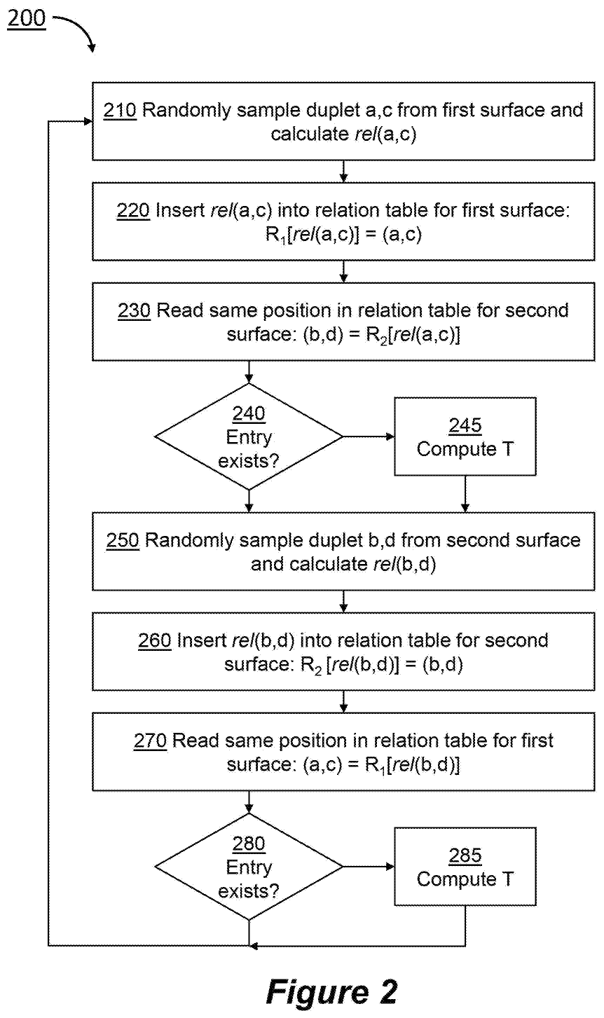

FIG. 2 is an example flowchart of a procedure 200 for matching duplet pairs. Duplets from a first 3D surface are matched with duplets from a second 3D surface to create matching duplet pairs. The first 3D surface comprises a first point cloud, wherein the first point cloud comprises multiple points, including for example, points a 110, and c 120. The second surface comprises a second point cloud, wherein the second point cloud comprises multiple points, including for example points b, and d. A first relation table R₁ may be built for the first surface, and a second relation table R₂ may be built for the second surface. The relation table (R₁, R₂) may comprise a relation table that holds the geometrical features of the sampled duplets. For example. a surface duplet (a,c) with geometrical features d_{ac} 130, α_{ac} 140, β_{ac} 150 and δ_{ac} 160 may be inserted into the relation table in the position rel(a,c) whereby

$$rel ( a , c ) = [ \begin{matrix}{d}_{a c} \\ cos {α}_{ac} \\ cos {β}_{ac} \\ {δ}_{ac}\end{matrix} ] . \qquad Equation ( 1 )$$

In block 210, a first surface duplet from a first 3D surface is randomly sampled. From the pair of points (a 110 and c 120) that comprise the first surface duplet (a,c), geometric features d_{ac} 130, α_{ac} 140, β_{ac} 150 and δ_{ac} 160 can be determined. After determination of the geometric features, the first surface duplet (a,c) may be inserted into the relation table R₁ of the first surface. The position of the first surface duplet (a,c) in the relation table R₁ is determined by a relation table index. The relation table index for the first surface duplet (a,c) is calculated as rel(a,c). The geometric features d_{ac} 130, α_{ac} 140, β_{ac} 150 and δ_{ac} 160 of the first surface duplet (a,c) are input into Equation (1) to calculate rel(a,c) i.e. the position of the first surface duplet (a,c) in the relation table R₁.

In block 220, the first surface duplet (a,c) is inserted into the relation table R₁ using the relation table index rel(a,c). Accordingly, an evaluation of R₁[rel(a,c)] in the relation table R₁ will retrieve the first surface duplet (a,c).

In block 230, the relation table R₂ of the second 3D surface is inspected in order to identify a geometrically congruent second duplet from the second surface. Using the relation table index rel(a,c) for the first surface duplet, the same position in the second relation R₂ for the second surface is inspected or accessed. Hence, when R₂[rel(a,c)] is evaluated, a second surface duplet (b,d) may be found.

In block 240, the existence of the second surface duplet (b,d) in the second relation table R₂ at position rel(a,c) is evaluated. If a second surface duplet (b,d) exists in relation table R₂, the procedure 200 follows a path to block 245. If a second surface duplet does not exist in the relation table R₂ at relation table index rel(a,c), then the procedure follows a path to block 250.

In block 245, a pose estimate T is calculated if a geometrically congruent second duplet (b,d) is found. The pose estimate T may be a homogenous 4×4 transformation that aligns the first surface duplet (a,c) with the second surface duplet (b,d). The pose estimate T may bring the duplets (a,c) and (b,d) in contact through rotation and/or translation of one of the surface duplets with respect to the other.

At block 250, the procedure of blocks 210 to 245 is repeated for the second 3D surface. A second surface duplet from the second 3D surface is randomly sampled. From the pair of points (b and d) that comprise the second surface duplet (b,d), the corresponding geometric features d_{bd}, α_{bd}, β_{bd} and δ_{bd} can be determined. After calculation of the geometric features, the second surface duplet (b,d) may be inserted into the relation table R₂ of the second surface. The position of the second surface duplet (b,d) in the relation table R₂ is determined by the relation table index, rel(b,d).

In block 260, the second surface duplet (b,d) is inserted into the relation table R₂ using the relation table index rel(b,d). Accordingly, an evaluation of R₂[rel(b,d)] will retrieve the second surface duplet (b,d).

In block 270, the relation table R₁ of the first 3D surface is inspected in order to identify a geometrically congruent first duplet from the first surface. Using the relation table index rel(b,d) for the second surface duplet, the same position in the first relation R₁ for the first surface is inspected or accessed. Hence, when R₁[rel(b,d)] is evaluated, a first surface duplet (a,c) may be found.

In block 280, the existence of the first surface duplet (a,c) in the first relation table R₁ at position rel(b,d) is evaluated. If a first surface duplet (a,c) exists, the procedure 200 follows a path to block 285. If a first surface duplet is does not exist in the relation table R₁ at relation table index rel(b,d), then the procedure follows a return path to block 210.

In block 285, a new pose estimate T is calculated, bringing the duplets (a,c) and (b,d) in contact. After calculation of the pose estimate T, the procedure 200 follows a return path to block 210. The blocks of the procedure 200 are repeated until the calculated pose estimate T satisfies a certain condition. The condition may be that the pose estimate T satisfies a quality condition, for example the first 3D surface and the second 3D surface are aligned by the pose estimate T within a pre-defined margin of error. Alternatively, the blocks of the procedure 200 may repeat until a pre-defined time limit has been exceeded, a pre-defined number of pose calculations have been made. Once the condition for repetition of the blocks of the procedure 200 is satisfied, the final pose estimate T may be utilized to align the first 3D surface with the second 3D surface, completing the 3D registration procedure. The 3D registration procedure as described in relation to FIG. 2 may be referred to as a random sample matching (RANSAM) procedure.

An intrinsic surface property of a 3D surface is a property which is constant regardless of the chosen co-ordinate system, position of a viewer relative to the surface and the chosen parametrization of the surface. One such intrinsic surface property is a Gaussian curvature of the surface. Another intrinsic surface property of a 3D surface that remains constant may be a texture of the surface. The texture may be the two-dimensional value of the texture or the color of the 3D surface.

The Gaussian curvature of a surface is a geometric property that may be used to understand and describe the curvature of the surface. The Gaussian curvature K of a surface at a point may be formally defined as the product of a principle curvature κ₁ and a principle curvature κ₂ at said point

K=κ₁κ₂.

At a given point on a surface, a normal vector is determined to be a vector which is at right angles to the surface. A normal plane is a plane which contains the normal vector. At the intersection of a normal plane and the surface, a curve may be formed which is called a normal section. The curvature of the normal section is defined as a normal curvature. For a given point on the surface, the maximum value of the normal curvature can be referred to as a principle curvature, κ₁. Similarly, the minimum value of the normal curvature at the given point on the surface can be referred to as another principle curvature, κ₂. The multiplication of the principle curvatures κ₁ and κ₂ provide the Gaussian curvature. The Gaussian curvature of a surface may be a positive value, a negative value or have a value of zero.

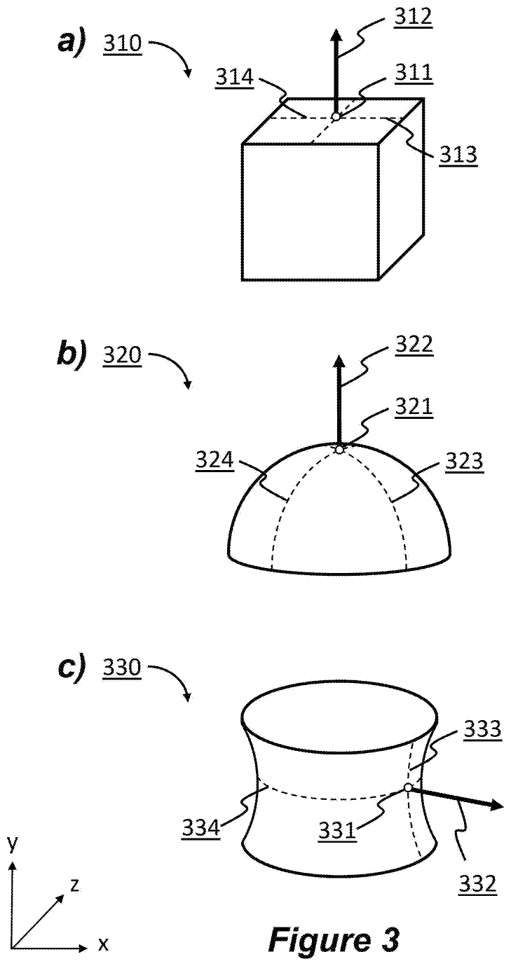

FIG. 3a is a schematic representation of an example of a 3D surface 310 with a Gaussian curvature of zero. A 3D surface 310 can take the shape of a cuboid, whereby at a given point 311, the surface of the cuboid is a flat plane. At the point 311 on the cube 310, a normal vector 312 can be determined. After determination of the normal vector 312, the principle curvatures of the surface at point 311 can be calculated as described above. The dashed line 313 represents a curve of principle curvature at point 311. Given the point 311 is on a flat plane, the curve of principle curvature κ₁ has a curvature of zero. Similarly, the dashed line 314 represents another curve of principle curvature at point 311, also with a curvature of zero. Thus, the Gaussian curvature, the product of the two principle curvatures, is also zero.

For a point on any surface, if one of the principle curvatures is zero, the Gaussian curvature of the point on the surface will be zero. As a result, the Gaussian curvature of flat planes and cylinders will be zero everywhere.

FIG. 3b is a schematic representation of an example of a 3D surface 320 with a positive Gaussian curvature. The 3D surface 320 takes the shape of a hemisphere. At a point 321 on the hemisphere 320, a normal vector 322 is determined. After determination of the normal vector 322, the principle curvatures of the surface at point 321 are calculated. The dashed line 323 represents a curve of principle curvature at point 311, whereby the curvature of the curve is positive. Similarly, the dashed line 324 represents another curve of principle curvature at point 321, also with a positive curvature (actually the same curvature since the surface is hemispherical). Thus, the Gaussian curvature of the hemisphere at point 322 is positive.

For a point on a surface, if both principle curvatures are the same sign e.g. both principle curvatures are positive or both principle curvatures are negative, the resulting Gaussian curvature is positive. In other words, the Gaussian curvature of a point on a surface is positive regardless of whether the point is a so-called hill or valley (peak or trough).

FIG. 3c is a schematic representation of an example of a 3D surface 330 with a negative Gaussian curvature. The 3D surface 330 takes the shape of a hyperboloid. At a point 331 on the surface of the hyperboloid 330, a normal vector is once again determined. After determination of the normal vector 332, the principle curvatures of the surface a point 331 are calculated. The dashed line 333 represents a curve of principle curvature at point 331, whereby the principle curvature is negative. Note that the curve of principle curvature 333 is in the opposite direction to the curves of positive curvature 323, 324 of FIG. 3b. The dashed line 334 represents another curve of principle curvature, whereby the principle curvature is positive (akin to the curves of positive curvature 323 and 324). As one principle curvature is negative and the other is positive, the resulting Gaussian curvature is therefore negative.

For a point on a surface whereby the principle curvatures have different signs, the Gaussian curvature for said point will be negative. As a result, the Gaussian curvatures for hyperboloids or saddle points are negative.

In some examples, in order to efficiently compute the approximate Gaussian curvature of points on a 3D surface, a method of discrete triangularization of the surface is utilized. In the method of discrete triangularization, a mesh of triangles is generated from the point cloud of a 3D surface. This results in the 3D surface being represented approximately by a mesh of triangles which covers the given 3D surface.

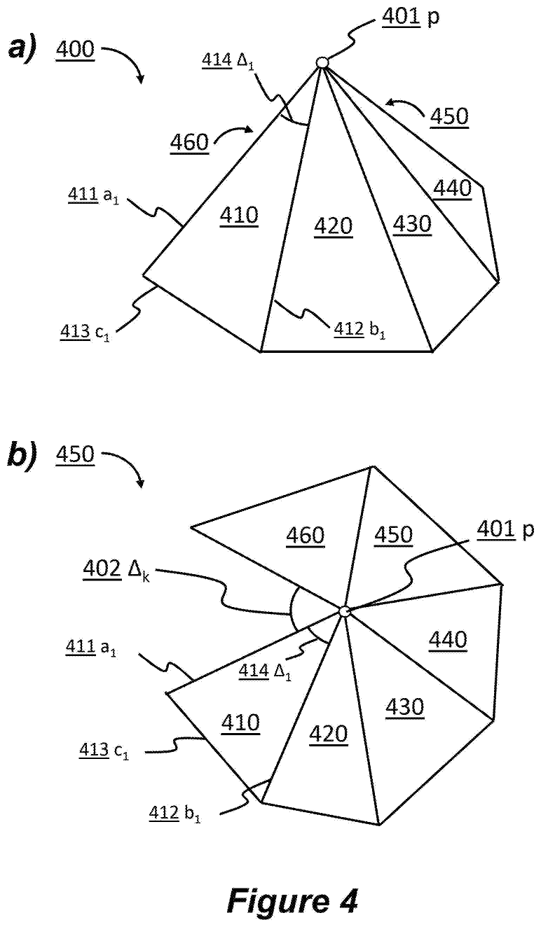

FIG. 4a is an example of a 3D schematic representation 400 of discrete triangularization of a 3D surface. The 3D surface is represented by multiple triangles 410, 420, 430, 440, 460. A point p 401 on the triangular mesh can be considered to be a vertex of the triangles 410, 420, 430, 440, 460. Each triangle, for example 410, may be defined by at least the length of side a₁ 411, the length of side b₁ 412, the length of side c₁ 414, and the angle Δ₁ 414. Although not shown in FIG. 4a for simplicity, the triangle 420 can be similarly defined by a₂, b₂, c₂ and Δ₂. Following convention, the triangle i can be defined by aᵢ, bᵢ, c₁ and Aᵢ.

FIG. 4b is an example of a 2D schematic representation 450 of discrete triangularization of a 3D surface. The 2D schematic representation 450 is a 2D planar view of the 3D surface 400 of FIG. 4a. The 2D schematic representation 450 allows for a graphical description of the calculation of the approximate Gaussian curvature of the point p 401 on the 3D surface.

The point p 401 on the 3D surface is at the vertex of the triangles 410, 420, 430, 440, 450 and 460. The approximate Gaussian curvature for the point p 401 can be calculated by summing the angles Δ₁, Δ₂ Δ₃, Δ₄, Δ₅ and Δ₆ for the triangles 410, 420, 430, 440, 450 and 460, respectively, and subtracting the summed angles from 2π (or 360°). As a result, the angle Δₖ 402 is calculated.

In general, the approximate Gaussian curvature for a point p at a vertex of N triangles may be computed as

$$\begin{matrix}K ( p ) = 2 π - {\sum }_{i = 1}^{N} {Δ}_{i} , & Equation ( 2 ) \\ where & \\ {Δ}_{i} = arccos ( \frac{{a}_{i}^{2} + {b}_{i}^{2} - {c}_{i}^{2}}{2 {a}_{i} {b}_{i}} ) . & Equation ( 3 )\end{matrix}$$

In other words, the angles Δᵢ of the N triangles surrounding the point p are summed together and subtracted from 2π (or 360°) to calculate the approximate Gaussian curvature of the point p.

The Gaussian curvature K(a) of a point a on a first 3D surface can be compared to the Gaussian curvature K(b) of point b on a second 3D surface. If the Gaussian curvatures K(a) and K(b) are within a pre-determined threshold ξ, the Gaussian curvatures are determined to be equivalent. Thereby satisfying

|K(a)−K(b)|<ξ. Equation (4)

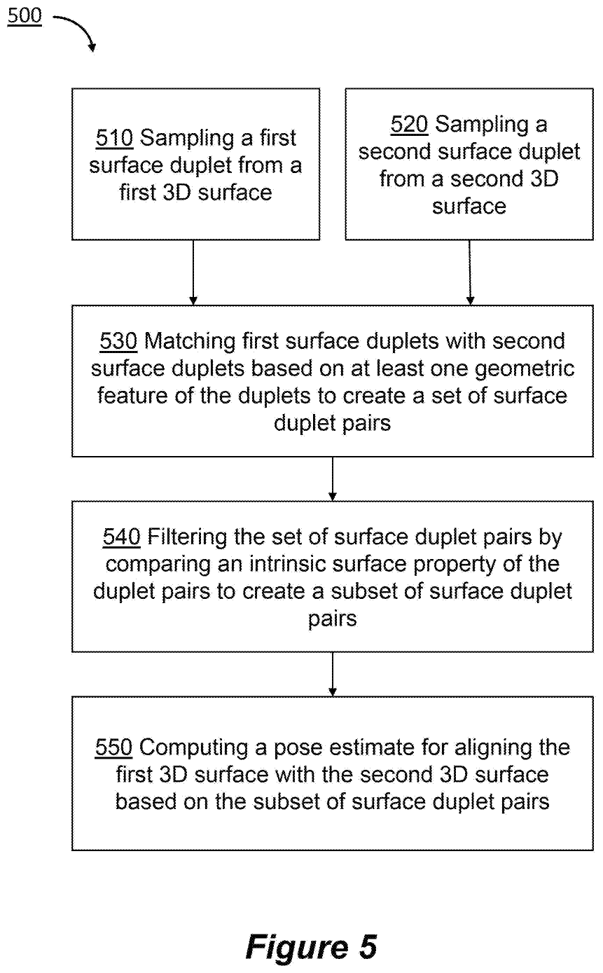

FIG. 5 is a block diagram of an example of a method 500 for performing a 3D registration procedure. In block 510, a pair of points from a first 3D surface is sampled to generate a first surface duplet. In block 520, a pair of points from a second surface is sampled to generate a second surface duplet.

In some examples, the sampling of the duplets from the second surface comprises random sampling. In other examples, sampling the duplets may be pseudo-random or follow a pre-determined sequence or pattern.

In some examples, a mesh of triangles may be generated from a 3D surface prior to the sampling of the surface duplet from the 3D surface. The mesh of triangles may be generated using discrete triangularization of the 3D surface. In other examples, a depth map of a 3D surface may be generated.

In some examples, an intrinsic surface property of each point from a point cloud of a 3D surface may be calculated prior to the sampling of the duplets from the 3D surface. The intrinsic surface property of the 3D surface may be a Gaussian curvature of the 3D surface. The Gaussian curvature of the surface may be calculated using discrete triangularization of the 3D surface or on a depth map of the 3D surface.

In some examples, the Gaussian curvature of the surface may be determined using the ratio of the determinants of the first and second fundamental forms of the 3D surface. The fundamental forms of a 3D surface are quadratic differential forms of the co-ordinates of the 3D surface. The fundamental forms characterize the intrinsic properties of the surface at a given point, and thus can be used to calculate the Gaussian curvature of the surface. The Gaussian curvature may be calculated by using the first and second fundamental terms or by using solely the first fundamental term and its derivatives.

In other examples, the intrinsic surface property of the 3D surface may be a local property of the 3D surface which is invariant under rotation and translation.

In block 530, duplets of the first surface duplets are matched with duplets of the second surface duplet based on at least one geometric feature of the duplets to create a set of first and second surface duplet pairs.

In some example, the duplets of the first surface duplets are matched with duplets of the second surface duplet using at least one relation table. A relation table may be referred to as a hash table.

A first relation table for the first surface may store first surface duplets that may have already been sampled. A second relation table for the second surface may store second surface duplets that may have already been sampled. The position of a duplet in the relation table may be determined by the geometric features of the duplet. As such, two duplets with identical geometrical features may have identical positions in a relation table.

In some examples, a relation table for a 3D surface may be populated prior to sampling the first surface duplet. Computational resources for the 3D registration procedure may decrease by pre-populating the relation table.

A first surface duplet of the first surface may be matched with a second surface duplet of the second surface by inspecting the first relation table and the second relation tables. Matching duplets of the first surface duplets with duplets of the second surface duplets may comprise inserting a first surface duplet into the first relation table and inspecting the same position in the second relation table for the presence of a second surface duplet. If the second surface duplet exists, the first surface duplet and the second surface duplet are geometrically congruent and may be considered to be matched. Together, the first surface duplet and the second surface duplet may be referred to as a first and second surface duplet pair. Matching duplets of the first surface duplets with duplets of the second surface duplets may create a set of surface duplet pairs.

In block 540, the set of first and second surface duplet pairs are filtered by comparing an intrinsic surface property of the first surface duplet and the second surface duplet of the duplet pairs to create a subset of first and second surface duplet pairs. In some examples, the intrinsic surface property may be a Gaussian curvature of the 3D surface.

In block 550, a pose estimate for aligning the first 3D surface with the second 3D surface is computed based on the subset of first and second surface duplet pairs. In some examples, the procedure 500 may be repeated until the pose estimate reaches or exceeds a pre-determined quality criterion. In other examples, the procedure 500 may be repeated until a pre-determined time limit has been exceeded.

While the present disclosure is described in relation to a first 3D surface and a second 3D surface, additional 3D surfaces may be envisaged. For example, when additional 3D surfaces exist, pairs of points from additional 3D surfaces may be sampled to generate additional surface duplets.

In some examples, the 3D registration procedure may initially be performed in order to align the first 3D surface with the second 3D surface. Once the first and second 3D surfaces are aligned, the 3D registration procedure may be performed again to align the additional 3D surface with the already-aligned first and second 3D surfaces.

In other examples, the 3D registration procedure may be performed to align the first 3D surface, the second 3D surface and additional 3D surfaces in parallel. As such, duplets of the additional surface duplets may be initially matched with duplets of the first surface duplets to create a set of first and additional surface duplet pairs. The first and additional surface duplet pairs may then be further matched with duplets of the second surface duplets to create a set of surface triplets. The set of surface triplets comprises matched first, second and additional surface duplets. The set of surface triplets may then be filtered by comparing an intrinsic surface property of the first, second and additional surface duplets of the set of surface triplets to create a subset of surface triplet pairs. A pose estimate may then be computed for aligning the first, second and additional 3D surfaces with each other based on the subset of the surface triplets.

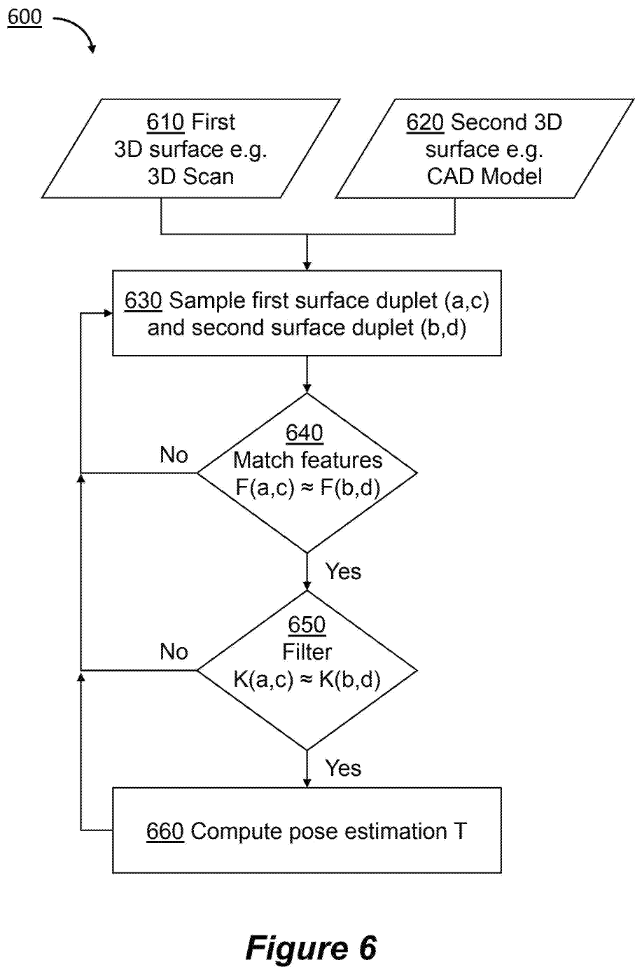

FIG. 6 is an example flowchart of a procedure 600 for performing 3D registration. In block 610, a first 3D surface is inputted into block 630. In block 620, a second 3D surface is inputted into block 630. A 3D surface may be a point cloud or may have been pre-computed as a triangular mesh. The Gaussian curvature of the 3D surface may have been pre-computed. The first 3D surface 610 may comprise of a 3D surface generate from a 3D scan of a real-world object. The second 3D surface 620 may comprise of a 3D model of an object or shape e.g. a computer aided design (CAD) model.

In some examples, pre-computing the Gaussian curvature of a 3D model of an object or shape may decrease the computational resources needed to perform the 3D registration procedure as the computation may only need to be performed once for a particular 3D model. Said 3D model may then be used in multiple 3D registration procedures.

In block 630, a pair of points (a and c) from the first 3D surface is sampled to generate a first surface duplet (a,c). A pair of points (b and d) from a second 3D surface is sampled to generate a second surface duplet (b,d).

In block 640, at least one geometric feature of the first surface duplet F(a,c) may be determined. Similarly, at least one geometric feature of the second surface duplet F(b,d) may be determined. The geometric features of the first surface duplet F(a,c) may then be matched with the geometric features of the second surface duplet F(b,d).

In some examples, the geometric features of the first surface duplet F(a,c) may be matched with the geometric features of the second surface duplet F(b,d) using a relation table. A first relation table may store the geometric features of first surface duplets e.g. F(a,c) that have already been sampled. Similarly, a second relation table may store the geometric features of second surface duplets e.g. F(b,d) that have already been sampled. The location of the sampled surface duplets in the relation table is determined by the geometric features of the surface duplets. Therefore, inspecting equivalent positions in the first relation table and the second relation table allows geometrically congruent surface duplets to be matched e.g. F(a,c)≈F(b,d). This may form a surface duplet pair (a,b,c,d) comprising the geometrically congruent first surface duplet (a,c) and second surface duplet (b,d).

If the geometric features of the first surface duplet F(a,c) are determined to match the geometric features of the second surface duplet F(b,d), then the procedure 600 follows a path to block 650. If the geometric features of the first surface duplet F(a,c) do not match the geometric features of the second surface duplet F(b,d), then the procedure follows a path to block 630. Here, another first surface duplet and/or another second surface duplet may be selected to continue the procedure.

In block 650, the surface duplet pairs (a,b,c,d) are filtered by comparing an intrinsic surface property of the first surface duplet and the second surface duplet. The intrinsic surface property of the duplets may be a Gaussian curvature of the surface.

In some examples, a Gaussian curvature of the first surface duplet (a,c) may be compared to a Gaussian curvature of the second surface duplet (b,d) from the surface duplet pairs (a,b,c,d). The Gaussian curvature of a point a from the first surface duplet (a,c) may be determined to be K(a) as given in Equation 2 above. Similarly, the Gaussian curvature of a point b from the second surface duplet (b,d) can be determined to be K(b). The Gaussian curvatures K(a) and K(b) may be compared, as described in Equation 4 above, to determine if the Gaussian curvatures of point a and point b are equivalent.

Similarly, the Gaussian curvature of point c from the first surface duplet (a,c) may be determined to be K(c) and the Gaussian curvature of point d from the second surface duplet (b,d) can be determined to be K(d). The Gaussian curvatures K(c) and K(d) are compared to determine if the Gaussian curvatures of point c and point d are equivalent.

If the Gaussian curvatures K(a) and K(c) from the first surface duplet are determined to be equivalent to the Gaussian curvatures K(b) and K(d) from the second surface duplet i.e.

|K(a)−K(b)|<ξ and |K(c)−K(d)|<ξ,

then the Gaussian curvature of the first surface duplet is said to be equivalent to the Gaussian curvature of the second surface duplet e.g. K(a,c)≈K(b,d). As a result, the procedure 600 then follows a path to block 660.

If the Gaussian curvature K(a) of the point a from the first surface duplet is determined to not be equivalent to the Gaussian curvature K(b) of the point b from the second surface duplet, and/or if the Gaussian curvature K(c) of the point c from the first surface duplet is determined to not be equivalent to the Gaussian curvature K(d) of the point d from the second surface duplet i.e.

|K(a)−K(b)|=>ξ and/or |K(c)−K(d)|=>ξ,

then the Gaussian curvature of the first surface duplet is said to not be equivalent to the Gaussian curvature of the second surface duplet e.g. K(a,c)≠K(b,d). As a result, the procedure 600 then follows a path that returns to block 630. Here, another first surface duplet and/or another second surface duplet may be selected to continue the procedure from block 630, in search of a surface duplet pair that have equivalent Gaussian curvatures.

In block 660, a pose estimate T is computed using the surface duplet pairs (a,b,c,d) in order to align the first 3D surface with the second 3D surface. The surface duplet pairs have been determined to be geometrically congruent in block 640 and have equivalent Gaussian curvatures in block 650. The pose estimate T may align the surface duplets (a,c) and (b,d), bringing them into contact with each other.

After calculation of the pose estimate T, the procedure 600 may return to block 630. The blocks of the procedure 600 may repeated until the calculated pose estimate T satisfies a certain condition. The condition may be that the pose estimate T satisfies a quality condition, for example the first 3D surface and the second 3D surface are aligned by the pose estimate T within a pre-defined margin of error. Alternatively, the blocks of the procedure 600 may have been repeated until a pre-defined time limit has been exceeded. Once the condition for repetition of the blocks of the procedure 600 is met, the final pose estimate T may be utilized to align the first 3D surface with the second 3D surface, completing the 3D registration procedure.

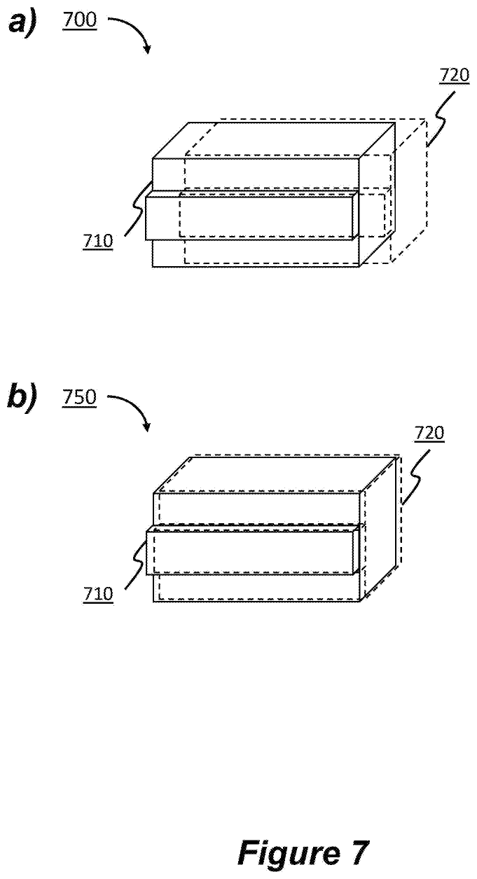

FIG. 7a is an example of a 3D registration result 700 of 3D registration procedure. The 3D registration procedure may be a RANSAM 3D registration procedure as described in relation to FIG. 2. A first 3D surface 710 may comprise 3D surface data from a 3D scanning procedure, as illustrated by the solid lines 710. A second 3D surface 720 may comprise 3D surface data from a CAD model, as illustrated by the dashed lines 720. Performing a RANSAM procedure may result in a 3D registration result 700 that may align the first 3D surface 710 with the second 3D surface 720 as illustrated in FIG. 7a. An inaccurate 3D registration result 700 may result whereby the first 3D surface 710 is not accurately aligned with the second 3D surface 720. This inaccurate alignment may be due to a lack of unique local features resulting from planar surfaces. The RANSAM procedure may maximize alignment of the planar surfaces in preference to the alignment of the small number of non-planar local features of the surfaces. FIG. 7a illustrates the first 3D surface 710 which has ‘slid’ with respect to the second 3D surface 720, due to the small number of non-planar local features present in the 3D surfaces 710, 720.

FIG. 7b is an example of a 3D registration result 750 of 3D registration procedure. The 3D registration procedure may be a 3D registration procedure of the present disclosure as described in relation to FIGS. 5 and 6. As described in relation to FIG. 7a, a first 3D surface 710 may comprise 3D surface data from a 3D scanning procedure, illustrated by the solid lines 710. A second 3D surface 720 may comprise 3D surface data from a CAD model, as illustrated by the dashed lines 720. Performing a 3D registration procedure of the present disclosure may result in a 3D registration result 750 that may align the first 3D surface 710 with the second 3D surface 720 as illustrated in FIG. 7b. By filtering the surface duplets by Gaussian curvature, only surface duplets with matching geometric features and equivalent Gaussian curvatures are used to compute the pose estimate for alignment. As a result, the 3D registration procedure may assist in aligning the small number of non-planar local features of the surfaces, in addition to the alignment of the planar surfaces. The 3D registration procedure of the present disclosure may address the sliding issue of FIG. 7a and may therefore provide a robust and accurate 3D registration procedure result.

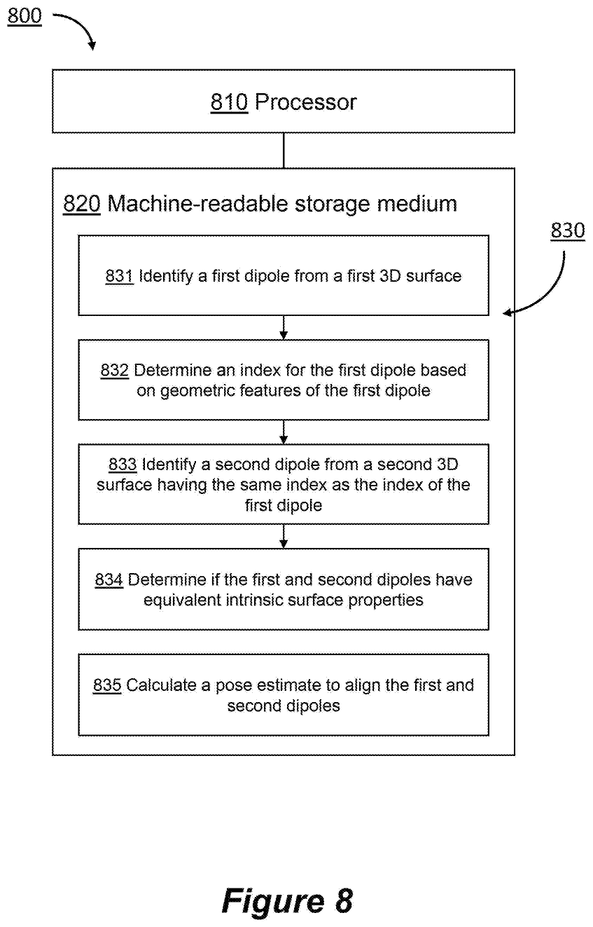

FIG. 8 is an example of a schematic diagram 800 of a processor 810 and machine-readable storage medium 820 for performing a 3D registration procedure. The machine-readable storage medium 820 comprises computer-readable instructions 830 for performing a 3D registration procedure which, when executed by at least one processor 810, cause the at least one processor 810 to perform a procedure according to examples described herein. The computer-readable instructions 830 may be retrieved from a machine-readable media, for example any media that can contain, store, or maintain programs and data for use by or in connection with an instruction execution system. In this case, machine-readable media can comprise any one of many physical media such as, for example, electronic, magnetic, optical, electromagnetic, or semiconductor media. More specific examples of suitable machine-readable media include, but are not limited to, a hard disk drive, a random-access memory (RAM), a read-only memory (ROM), an erasable programmable read-only memory, or a portable disc.

At block 831 the instructions cause the processor 810 to identify a first dipole from a first 3D surface, wherein a dipole comprises a pair of orientated points from a 3D surface. At block 832 the instructions cause the processor 810 to determine an index for the first dipole based on the geometric features of the first dipole. At block 833 the instructions cause the processor 810 to identify a second dipole from a second 3D surface having the same index as the index of the first dipole. At block 834 the instructions cause the processor 810 to determine if the first and second dipoles have equivalent intrinsic surface properties by comparing the intrinsic surface properties of the first and second dipoles. At block 835 the instructions cause the processor 810 to calculate a pose estimate to align the first and second dipoles in response to determining the first and second dipoles have equivalent intrinsic surface properties.

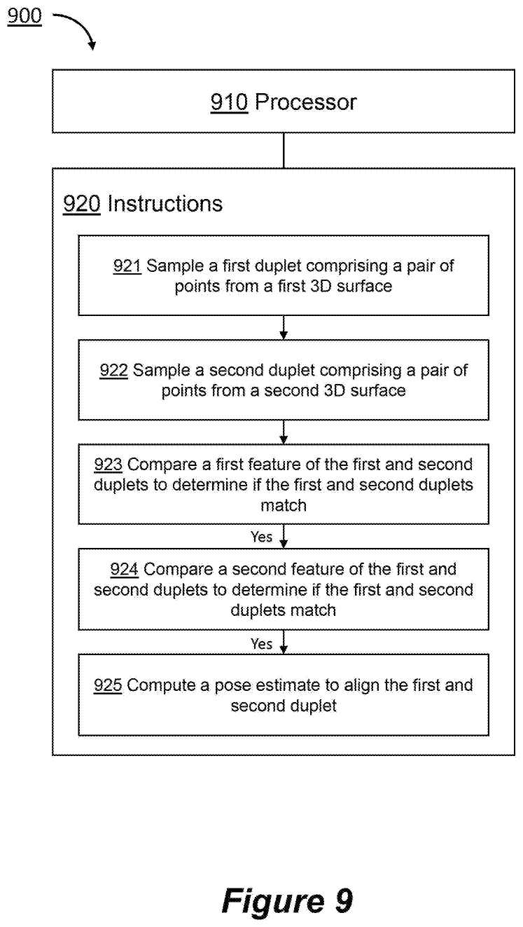

FIG. 9 is an example of a schematic diagram of a computer system 900 comprising a processor 910 and a set of instructions 920. The set of instructions 920 are set to cooperate with the processor 910 to perform a 3D registration procedure according to examples described herein.

At block 921 the instructions 920 cause the processor 910 to sample a first duplet comprising a pair of points from a first 3D surface. At block 922 the instructions 920 cause the processor 910 to sample a second duplet comprising a pair of points from a second 3D surface. At block 923 the instructions 920 cause the processor 910 to compare a first feature of the first and second duplets to determine if the first and second duplets match. The first feature of the first and second duplets may be a geometric feature. If the first and second duplets match based on the first feature, then at block 924 the instructions 920 cause the processor 910 to compare a second feature of the first and second duplets to determine if the first and second duplets match. The second feature of the first and second duplets may be a surface property e.g. Gaussian curvature of a duplet. If the first and second duplets match based on the second feature, then at block 925 the instructions 920 cause the processor 910 to compute a pose estimate to align the first and second duplet.

The preceding description has been presented to illustrate and describe examples of the principles described. This description is not intended to be exhaustive or to limit these principles to any precise form disclosed. Features of individual examples may be combined in different configurations, including those not explicitly set out herein. Many modifications and variations are possible in light of the above teaching, for example, using an intrinsic surface property such as the texture of a 3D surface to filter the set of surface duplet pair to create a subset of surface duplet pairs. The texture of a 3D surface may be the 2D texture or the color of the surface.

1. A method comprising:
sampling pairs of points from a first three-dimensional surface to generate first surface duplets;
sampling pairs of points from a second three-dimensional surface to generate second surface duplets;
matching duplets of the first surface duplets with duplets of the second surface duplets based on at least one geometric feature of the duplets to create a set of first and second surface duplet pairs;
filtering the set of first and second surface duplet pairs by comparing an intrinsic surface property of the first surface duplet and the second surface duplet of the duplet pairs to create a subset of first and second surface duplet pairs; and
computing a pose estimate for aligning the first three-dimensional surface with the second three-dimensional surface based on the subset of first and second surface duplet pairs.

2. A method according to claim 1, wherein the intrinsic surface property comprises a Gaussian curvature of the surface.

3. A method according to claim 2, wherein the Gaussian curvature of the surface is calculated at a point on the surface.

4. A method according to claim 3, wherein the Gaussian curvature of the surface is calculated prior to sampling pairs of points from the surface.

5. A method according to claim 3, wherein the Gaussian curvature of the surface is calculated using discrete triangularization of the surface.

6. A method according to claim 1, wherein points from the surface comprise orientated points, an orientated point comprising the position of the point in three dimensions and a corresponding surface normal of the point.

7. A method according to claim 1, wherein matching comprises using a relation table comprising sampled surface duplets for a three-dimensional surface.

8. A method according to claim 1, wherein sampling comprises random sampling.

9. A method according to claim 1, wherein computing a pose estimate comprises calculating a homogenous transformation matrix.

10. A method according to claim 1, wherein a geometric feature of the surface duplet comprises:
the Euclidean distance along a line connecting a first point to a second point of the pair of points that forms the surface duplet;
the angle between a first normal of the first point and the line connecting the points of the surface duplet;
the angle between a second normal of the second point and the line connecting the points of the surface duplet; or
the angle between the first normal and the second normal around the line connecting the points of the surface duplet.

11. A non-transitory machine-readable storage medium encoded with instructions executable by a processor, the machine-readable storage medium comprising:
instructions to identify a first dipole from a first three-dimensional surface, wherein a dipole comprises a pair of orientated points from a three-dimensional surface;
instructions to determine an index for the first dipole based on geometric features of the first dipole;
instructions to identify a second dipole from a second three-dimensional surface having the same index as the index of the first dipole;
instructions to determine if the first and second dipoles have equivalent intrinsic surface properties by comparing the intrinsic surface properties of the first and second dipoles; and
instructions to calculate a pose estimate to align the first and second dipoles in response to determining the first and second dipoles have equivalent intrinsic surface properties.

12. A method according to claim 11, wherein the intrinsic surface property comprises a Gaussian curvature of the surface.

13. A computer system comprising:
a processor;
instructions set to cooperate with the processor to:
sample a first duplet comprising a pair of points from a first three-dimensional surface;
sample a second duplet comprising a pair of points from a second three-dimensional surface;
compare a first feature of the first and second duplets to determine if the first and second duplets match;
if the first and second duplets match based on the first feature, then compare a second feature of the first and second duplets to determine if the first and second duplets match; and
if the first and second duplets match based on the second feature, then compute a pose estimate to align the first and second duplet.

14. A method according to claim 13, wherein the first feature comprises a geometric feature and the second feature comprises a surface property.

15. A method according to claim 13, wherein the surface property comprises a Gaussian curvature of the duplets.
